(19) United States
(12) Patent Application Publication
(10) Pub. No.: US 2025/0174408 A1
(43) Pub. Date: May 29, 2025

(54) HYBRID CAPACITOR AND METHOD OF MANUFACTURING THE SAME

(71) Applicant: ELSPES Inc., Daejeon (KR)

(72) Inventors: Ui Hwan KIM, Hwaseong-si (KR); Yeong Yeol PARK, Yongin-si (KR); Tae Dong KIM, Hwaseong-si (KR); Hee Il CHAE, Hwaseong-si (KR)

(21) Appl. No.: 18/608,962

(22) Filed: Mar. 19, 2024

(30) Foreign Application Priority Data
Nov. 28, 2023 (KR) 10-2023-0168068

(51) Int. Cl. H01G 4/38; H01G 4/012; H01G 4/33

(52) U.S. Cl. CPC H01G 4/385; H01G 4/012; H01G 4/33

(57) ABSTRACT

The present invention relates to a hybrid capacitor and a method of manufacturing the same. The hybrid capacitor according to one embodiment of the present invention includes a silicon substrate, a first capacitor pattern disposed on the silicon substrate along a plurality of first trenches, an oxide layer formed on the silicon substrate on which the first capacitor pattern is disposed, a second capacitor pattern disposed on the oxide layer along a plurality of second trenches, and a through-hole configured to electrically connect the first capacitor pattern and the second capacitor pattern.

### CROSS-REFERENCE TO RELATED APPLICATION

This application claims priority to and the benefit of Korean Patent Application No. 2023-0168068, filed on Nov. 28, 2023, the disclosure of which is incorporated herein by reference in its entirety.

### BACKGROUND

### 1. Field of the Invention

The present invention relates to a hybrid capacitor, and more specifically, to a hybrid capacitor having a structure in which a deep trench capacitor and a stack capacitor are coupled, and a method of manufacturing the same.

### 2. Discussion of Related Art

Recently, high-performance system-on-chips (SOCs) have been used and applied in smartphones, artificial intelligence, autonomous vehicles, the Internet of Things, and the like. There is a need to develop technologies for reducing power noise, switching noise, and the like in a high frequency range (frequency band of hundreds of MHz).

In order to solve such a problem, capacitors which are passive components with enhanced energy storage capabilities may be used. In particular, as a part of implementing large capacitance of capacitors, research and development is continuously being conducted on trench capacitors which may be integrated and have superior electric storage performance and reliability to multi-layer ceramic capacitors (MLCCs) and single layer capacitors (SLCs).

Since capacitors are implemented through trenches formed in a silicon substrate, trench capacitors have an advantage in that sufficient capacitance may be secured without a problem of step difference as compared with stack capacitors. In particular, as one method of increasing the capacitance of a trench capacitor, a method using a deep trench type capacitor is widely used.

However, deep trench capacitors have a problem of being vulnerable to stress applied to a silicon substrate due to a deep trench structure formed on the silicon substrate to increase the capacitance of a capacitor.

Furthermore, in order to further miniaturize capacitors, an electrode layer or a dielectric layer should be made thinner or smaller, which poses a technical limitation in increasing the capacitance of the capacitor.

Meanwhile, the information in the background art described above was obtained by the inventors for the purpose of developing the present invention or was obtained during the process of developing the present invention. As such, it is to be appreciated that this information did not necessarily belong to the public domain before the patent filing date of the present invention.

### RELATED ART DOCUMENTS

### Patent Documents

(Patent Document 1) Korean Patent No. 10-1487599 (Jan. 22, 2015)

### SUMMARY OF THE INVENTION

The present invention is directed to providing a hybrid capacitor and a method of manufacturing the same in which two capacitor patterns disposed to be separated into upper and lower sides by an oxide layer are connected in parallel through a through-hole, thereby addressing a shortcoming of a deep trench capacitor and also increasing capacitance.

The present invention is also directed to providing a hybrid capacitor and a method of manufacturing the same in which a second capacitor pattern is formed after an oxide layer is formed on a first capacitor pattern formed on a silicon substrate, thereby increasing capacitance and also omitting a separate joining process and an aligning process for the oxide layer to form the second capacitor pattern.

The present invention is also directed to a hybrid capacitor and a method of manufacturing the same, which is capable of constructing a capacitor with high capacitance within a thin and narrow area and solving a problem that a wafer is vulnerable during a process of grinding silicon to be thin for such a construction.

The objects of the present invention are not limited to those described above, and other objects not described may become apparent to those of ordinary skill in the art based on the following descriptions.

According to an aspect of the present invention, there is provided a hybrid capacitor including a silicon substrate, a first capacitor pattern disposed on the silicon substrate along a plurality of first trenches, an oxide layer formed on the silicon substrate on which the first capacitor pattern is disposed, a second capacitor pattern disposed on the oxide layer along a plurality of second trenches, and a through-hole configured to electrically connect the first capacitor pattern and the second capacitor pattern.

According to another aspect of the present invention, there is provided a method of manufacturing a hybrid capacitor, the method including forming a plurality of first trenches in a silicon substrate, forming a first capacitor pattern on the silicon substrate along the plurality of first trenches, forming an oxide layer on the first capacitor pattern, forming a plurality of second trenches in the oxide layer, forming a second capacitor pattern on the oxide layer along the plurality of second trenches, and forming a through-hole passing through at least a portion of the second capacitor pattern and the oxide layer, wherein the through-hole includes a conductive connection pattern configured to electrically connect the first capacitor pattern and the second capacitor pattern.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a plan view of a hybrid capacitor according to one embodiment of the present invention;

FIG. 2A is a cross-sectional view along line II-II′ of FIG. 1 according to one embodiment, and FIG. 2B is a cross-sectional view along line III-III′ of FIG. 1 according to one embodiment;

FIG. 3 is a plan view of a hybrid capacitor according to another embodiment of the present invention;

FIG. 4 is a flowchart illustrating a method of manufacturing a hybrid capacitor according to one embodiment of the present invention; and

FIGS. 5 to 8 are cross-sectional views sequentially illustrating a method of manufacturing a hybrid capacitor according to one embodiment of the present invention.

### DETAILED DESCRIPTION OF EXEMPLARY EMBODIMENTS

The advantages and features of the present invention and methods of accomplishing the same will become apparent from the following description of the embodiments in detail, taken in conjunction with the accompanying drawings. However, the present invention is not limited to the embodiments disclosed herein but will be implemented in various forms. The embodiments are provided so that the present invention is completely disclosed, and a person of ordinary skilled in the art can fully understand the scope of the present invention. Therefore, the present invention will be defined only by the scope of the appended claims.

A shape, a size, a ratio, an angle, and a number disclosed in the drawings for describing embodiments of the present invention are merely an example, and thus, the present invention is not limited to the illustrated details. In addition, in describing the present invention, when it is determined that the specific description of the known related art unnecessarily obscures the gist of the present invention, the detailed description thereof will be omitted. The terms such as “including,” “having,” and “consist of” used herein are generally intended to allow other components to be added unless the terms are used with the term “only.” Any references to singular may include plural unless expressly stated otherwise.

Components are interpreted to include an ordinary error range even if not expressly stated.

When the position relation between two parts is described using the terms such as “on,” “above,” “below,” and “next,” one or more parts may be positioned between the two parts unless the terms are expressly limited, for example, by the terms such as “immediately” or “directly.”

When an element or layer is disposed “on” another element or layer, one or more additional layers or elements may be interposed directly on the other element or therebetween.

Although the terms first, second, and the like are used to describe various components, these components are not limited by these terms. These terms are merely used to distinguish one component from another. Therefore, a first component to be described below may be a second component in a technical concept of the present invention.

Unless otherwise specified, like reference numerals refer to like elements throughout the specification.

The features of various embodiments of the present invention can be partially or entirely adhered to or combined with each other and can be interlocked and operated in technically various ways as understood by those skilled in the art, and the embodiments can be carried out independently of or in association with each other.

An area and a thickness of each component illustrated in the drawing are illustrated for convenience of description, and the present invention is not necessarily limited to the area and the thickness of the component illustrated.

The features of various embodiments of the present invention can be partially or entirely adhered to or combined with each other and can be interlocked and operated in technically various ways, and the embodiments can be carried out independently of or in association with each other.

Hereinafter, various embodiments of the present invention will be described in detail with reference to the accompanying drawings.

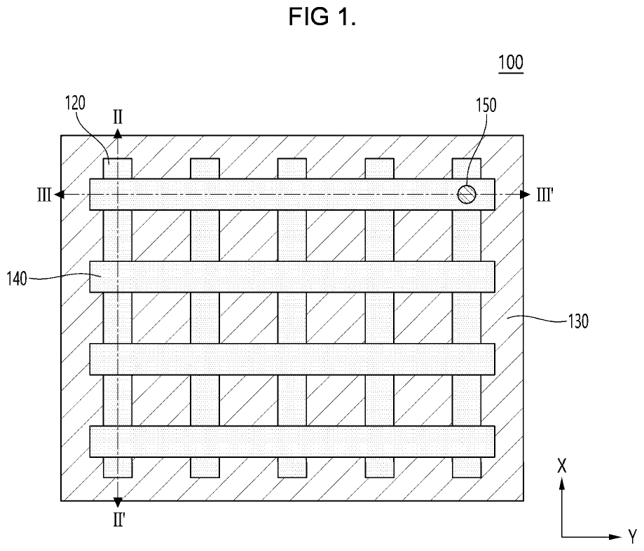

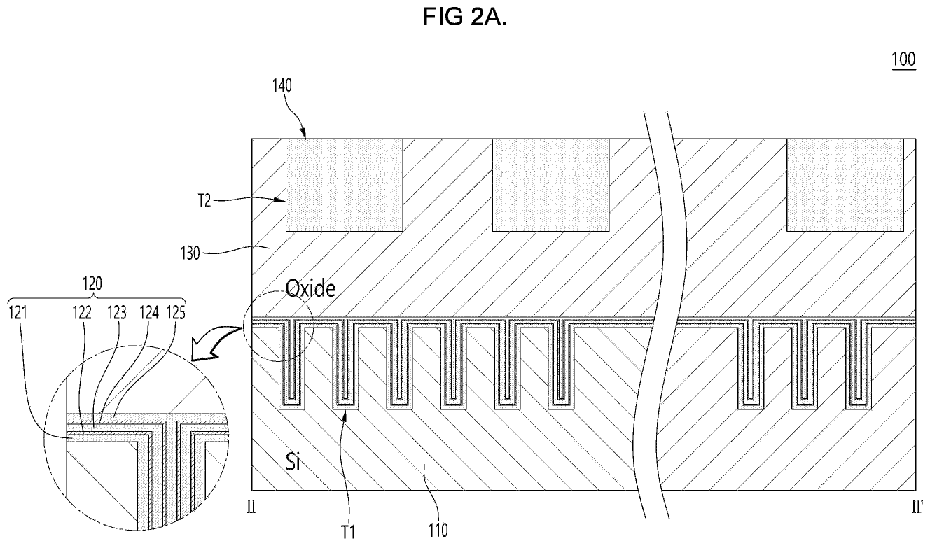

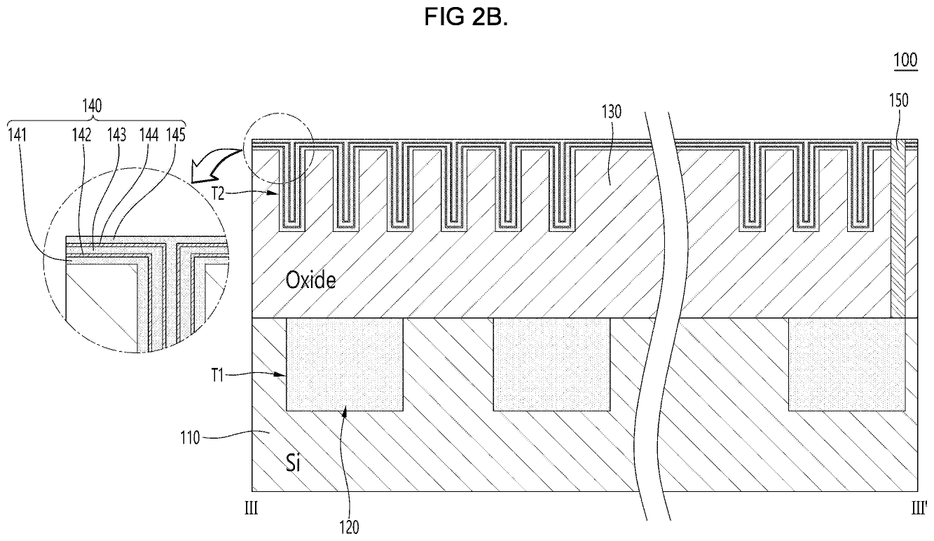

FIG. 1 is a plan view of a hybrid capacitor according to one embodiment of the present invention. FIG. 2A is a cross-sectional view along line II-II′ of FIG. 1 according to one embodiment. FIG. 2B is a cross-sectional view along line III-III′ of FIG. 1 according to one embodiment.

Referring to FIGS. 1, 2A, and 2B, a hybrid capacitor 100 according to one embodiment of the present invention may include a silicon substrate 110, a first capacitor pattern 120 formed on the silicon substrate 110, an oxide layer 130 formed on the silicon substrate 110 on which the first capacitor pattern 120 is formed, a second capacitor pattern 140 formed on the oxide layer 130, and a through-hole 150 for electrically connecting the first capacitor pattern 120 and the second capacitor pattern 140.

The silicon substrate 110 may be a p-type silicon substrate or an n-type silicon substrate. For example, the silicon substrate 110 may be made of silicon with a silicon crystal orientation of (1, 1, 0).

Referring to FIGS. 1, 2A, and 2B, the first capacitor pattern 120 may be formed on an upper surface of the silicon substrate 110 along a plurality of first trenches T1 formed in the silicon substrate 110. The first plurality of trenches T1 may be formed by cutting the silicon substrate 110 at an angle of 90 degrees from the upper surface to a lower surface. The plurality of first trenches T1 may each be a deep trench formed at a high aspect ratio to have a certain depth of, for example, 50 μm or more or 100 μm or more, and may be disposed to be spaced apart from each other by a certain interval of, for example, 1 μm to 3 μm.

Referring to FIGS. 1, 2A, and 2B, the first capacitor pattern 120 may include a first capacitor electrode layer 121, a first capacitor dielectric layer 122, and a second capacitor electrode layer 123 which are formed on the silicon substrate 110 along the plurality of first trenches T1. The first capacitor electrode layer 121, the first capacitor dielectric layer 122, and the second capacitor electrode layer 123 may be sequentially stacked on the upper surface of the silicon substrate 110 along the first trenches T1. Accordingly, the first capacitor pattern 120 may include the first capacitor electrode layer 121 formed on the upper surface of the silicon substrate 110 along the plurality of first trenches T1, the first capacitor dielectric layer 122 formed to cover at least one surface of the first capacitor electrode layer 121, and the second capacitor electrode layer 123 formed to cover at least one surface of the first capacitor dielectric layer 122.

Furthermore, the first capacitor pattern 120 may further include at least one first additional capacitor dielectric layer that covers the second capacitor electrode layer 123 and at least one first additional electrode layer that may be disposed alternately with the first additional capacitor dielectric layer. Accordingly, in the first capacitor pattern 120, a plurality of capacitor electrode layers and a plurality of capacitor dielectric layers may be alternately stacked or disposed, and a deep trench capacitor may be formed through such a structure. As such, in one embodiment of the present invention, the first capacitor pattern 120 is shown as including the first capacitor electrode layer 121, the first capacitor dielectric layer 122, and the second capacitor electrode layer 123, but the present invention is not limited thereto. The number of capacitor dielectric layers and the number of capacitor electrode layers may be appropriately selected according to a design.

The first capacitor dielectric layer 122 may be formed to include, for example, SiO, SiN, SiC, SiOC, SiON, SiCN, Si₃N₄, AlO, AlON, ZrO, or a high-k material, but the material of the capacitor dielectric layer is not limited by the described examples, and various dielectrics may be used. The first capacitor electrode layer 121 and the second capacitor electrode layer 123 may be made of a conductive material, for example, tungsten, copper, aluminum, doped silicon, or a compound thereof. The material of such a capacitor electrode layer is not limited by the described examples and may include various conductive materials.

The oxide layer 130 may be disposed on the silicon substrate 110 on which the first capacitor pattern 120 is formed. The oxide layer 130 may be made of an insulating material including oxide. For example, the oxide layer 130 may be made of a material such as SiO, SiON, AlO, AlON, or ZrO. The oxide layer 130 may be disposed to correspond to a length and width of the silicon substrate 110.

Referring to FIGS. 1, 2A, and 2B, the second capacitor pattern 140 may be formed on an upper surface of the oxide layer 130 along a plurality of second trenches T2. On the upper surface of the oxide layer 130, each of the plurality of second trenches T2 may be formed to correspond to the plurality of first trenches T1. Specifically, on the upper surface of the oxide layer 130, the second capacitor pattern 140 may be formed in a corresponding shape at a position corresponding to a shape of the first capacitor pattern 120 up and down. That is, the second capacitor pattern 140 may be formed to have the second trench T2 having a shape corresponding to the first trench T1 at a corresponding position on the first capacitor pattern 120. In addition, the second capacitor pattern 140 may be formed to correspond to a preset number of first trenches T1 at the corresponding position on the first capacitor pattern 120 on the oxide layer 130.

Furthermore, each of the plurality of second trenches T2 may be formed by cutting the oxide layer 130 at an angle of 90 degrees from the upper surface of the oxide layer 130 with respect to the surface of the oxide layer 130. In addition, each of the plurality of second trenches T2 may be formed to have the same depth and width as the plurality of first trenches T1 disposed in the silicon substrate 110. The plurality of second trenches T2 may each be a deep trench formed at a high aspect ratio to have a certain depth of, for example, 50 μm or more or 100 μm or more, and may be disposed to be spaced apart from each other by a certain interval of, for example, 1 μm to 3 μm.

In addition, the second capacitor pattern 140 may include a third capacitor electrode layer 141 formed on the upper surface of the oxide layer 130 along the plurality of second trenches T2, a second capacitor dielectric layer 142 formed to cover at least one surface of the third capacitor electrode layer 141, and a fourth capacitor electrode layer 143 formed to cover at least one surface of the second capacitor dielectric layer 142.

Furthermore, similar to the first capacitor pattern 120, the second capacitor pattern 140 may further include at least one second additional capacitor dielectric layer covering the fourth capacitor electrode layer 143 and at least one second additional electrode layer that may be disposed alternately with the second additional capacitor dielectric layer. Accordingly, in the second capacitor pattern 140, a plurality of capacitor electrode layers and a plurality of capacitor dielectric layers may be alternately stacked or disposed, and a deep trench capacitor may be formed through such a structure. Likewise, the second capacitor pattern 140 of the hybrid capacitor 100 according to one embodiment of the present invention are shown as including one second capacitor dielectric layer 142 and two capacitor electrode layers 141 and 143 like the first capacitor pattern 120, but the present invention is not limited thereto. The number of second capacitor dielectric layers 142 and the number of third and fourth capacitor electrode layers 141 and 143 may be appropriately selected according to design specifications.

The second capacitor dielectric layer 142 may be made of the same material as the first capacitor dielectric layer 122. For example, the second capacitor dielectric layer 142 may be formed to include SiO, SiN, SiC, SiOC, SiON, SiCN, Si₃N₄, AlO, AlON, ZrO, or a high-k material. The material of such a capacitor dielectric layer is not limited by the described examples, and various dielectrics may be used. The third capacitor electrode layer 141 and the fourth capacitor electrode layer 143 may be made of the same conductive material as the first capacitor electrode layer 121 and the second capacitor electrode layer 123. For example, the third capacitor electrode layer 141 and the fourth capacitor electrode layer 143 may be made of tungsten, copper, aluminum, doped silicon, or a compound thereof. The material of such a capacitor electrode layer is not limited by the described examples and may include various conductive materials.

As such, in the hybrid capacitor 100 according to one embodiment of the present invention, the first capacitor pattern 120 in the form of a deep trench is disposed on the silicon substrate 110, the oxide layer 130 is formed on the first capacitor pattern 120, and then the second capacitor pattern 140 in the form of a deep trench is formed on the oxide layer 130, thereby considerably increasing capacitance.

Referring to FIG. 1, the first capacitor pattern 120 is arranged in a first direction (X direction), and the second capacitor pattern 140 is arranged in a second direction (Y direction) which is a direction perpendicular to the first direction (X direction). That is, the first capacitor pattern 120 is arranged at an angle of 90 degrees with respect to an arrangement direction of the second capacitor pattern 140 on a plane of the silicon substrate 110.

As such, the hybrid capacitor 100 according to one embodiment of the present invention may be formed such that the first capacitor pattern 120 and the second capacitor pattern 140 are arranged in directions perpendicular to each other on one plane, and thus stress applied to the first capacitor pattern 120 and stress applied to the second capacitor pattern 140 may be offset. In addition, the hybrid capacitor 100 according to one embodiment of the present invention may be formed such that the plurality of first trenches T1 disposed in the silicon substrate 110 and the plurality of second trenches T2 disposed in the oxide layer 130 have the same depth and width, and thus a stress offset effect may be further improved.

Referring to FIGS. 1 and 2A, the first capacitor pattern 120 may be continuously disposed in the first direction, and the second capacitor patterns 140 may be disposed at a preset interval in the second direction on the first capacitor pattern 120. In FIG. 2A, a width of one second trench T2 in the second capacitor pattern 140 may correspond to the total width of three first trenches T1. According to various embodiments of the present invention, the number of first trenches T1 corresponding to the width of one second trench T2 may be changed.

Referring to FIGS. 1 and 2B, the second capacitor pattern 140 may be continuously disposed in the second direction, and the first capacitor patterns 120 may be spaced at a preset interval in the first direction below the second capacitor pattern 140. In FIG. 2B, a width of one first trench T1 in the first capacitor pattern 120 may correspond to the total width of three second trenches T2. According to various embodiments of the present invention, the number of second trenches T2 corresponding to the width of one first trench T1 may be changed.

In addition, referring to FIGS. 1 and 2B, the through-hole 150 electrically connects the first capacitor pattern 120 and the second capacitor pattern 140. Accordingly, the through-hole 150 may include a conductive connection pattern that electrically connects the first capacitor pattern 120 and the second capacitor pattern 140. In addition, the through-hole 150 may be formed to pass through at least a portion of the second capacitor pattern 140 and the oxide layer 130. Specifically, the through-hole 150 may pass through at least a portion of the second capacitor pattern 140 and the oxide layer 130 and thus may be formed to electrically connect the first capacitor electrode layer 121 or the second capacitor electrode layer 123 of the first capacitor pattern 120 and the third capacitor electrode layer 141 or the fourth capacitor electrode layer 143 of the second capacitor pattern 140. Accordingly, the through-hole 150 may be a through-via (TSV), a through-electrode, a metal electrode, or the like.

The through-hole 150 serves to connect the second capacitor pattern 140 disposed on the first capacitor pattern 120 to the first capacitor pattern 120 in parallel. Accordingly, the capacitance of the hybrid capacitor 100 according to one embodiment of the present invention may be the sum of that of the first capacitor pattern 120 and that of the second capacitor pattern 140 so that capacitance may be increased as compared with the existing one.

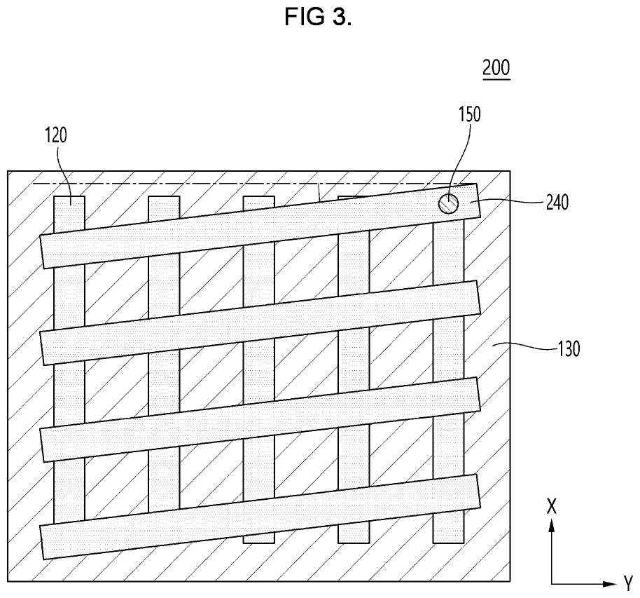

FIG. 3 is a plan view of a hybrid capacitor according to another embodiment of the present invention. Other configurations of a hybrid capacitor 200 in FIG. 3 are substantially the same as those in FIG. 1 except that a direction in which a second capacitor pattern 240 extends on a plane of an oxide layer 130 is different from that in FIG. 1, and thus a redundant description will be omitted.

Referring to FIG. 3, the hybrid capacitor 200 according to another embodiment of the present invention may include a silicon substrate 110, a first capacitor pattern 120, the oxide layer 130, the second capacitor pattern 240, and a through-hole 150.

The first capacitor pattern 120 may be arranged in a first direction (X direction) according to the crystal orientation of the silicon substrate 110. The second capacitor pattern 240 may be formed on the oxide layer 130 rather than on the silicon substrate so that the second capacitor pattern 240 may be arranged to form various angles rather than 90 degrees with the first capacitor pattern 120 arranged in a first direction (X direction) on a plane of the silicon substrate 110, Referring to FIG. 3, the second capacitor pattern 240 may be arranged in a direction forming an acute angle with the first direction (X direction) according to the characteristics of the oxide layer 130. In addition, according to various embodiments of the present invention, although not shown in FIG. 3, the second capacitor pattern 240 may also be arranged in a direction forming an obtuse angle with the first capacitor pattern 120 arranged in the first direction (X direction).

As such, the hybrid capacitor 100 according to another embodiment of the present invention is formed such that the first capacitor pattern 120 and the second capacitor pattern 140 intersect each other in different directions to be vertically stacked on an X-Y plane. Accordingly, the hybrid capacitor 100 according to another embodiment of the present invention may strongly withstand physical force applied from the outside in a specific direction. That is, the hybrid capacitor 100 of the present invention may have higher strength than other existing wafer-based capacitors.

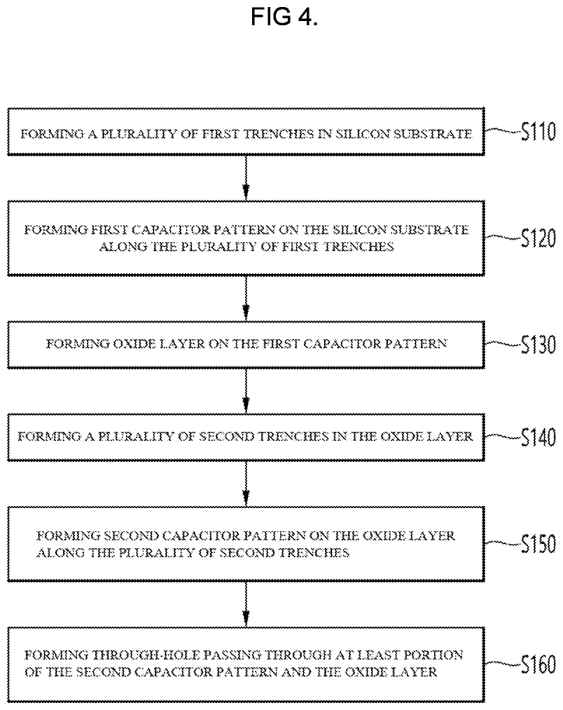

A manufacturing process of a hybrid capacitor 100 according to one embodiment of the present invention as described above will be described in more detail with reference to FIGS. 4 to 8 below.

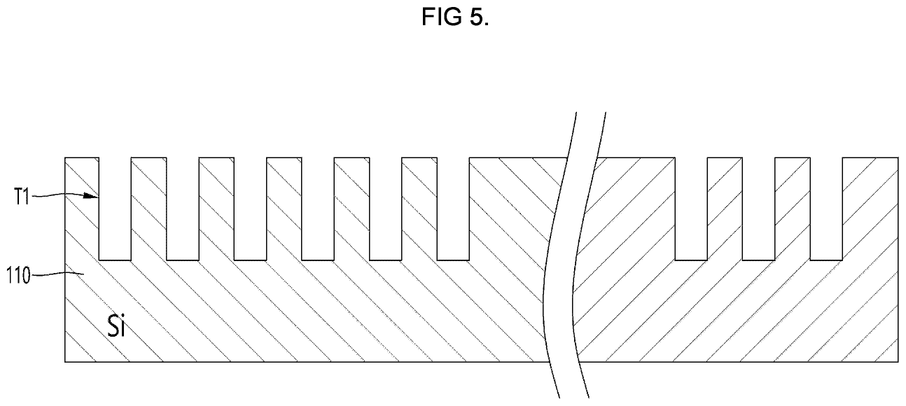

FIG. 4 is a flowchart illustrating a method of manufacturing a hybrid capacitor according to one embodiment of the present invention. FIGS. 5 to 8 are cross-sectional views for describing the method of manufacturing a hybrid capacitor according to one embodiment of the present invention. In order to describe processes of the method of manufacturing a hybrid capacitor and help understanding thereof, FIGS. 5 to 8 illustrate a combination of a cross-sectional portion of a silicon substrate 110 and a first capacitor pattern 120 along line II-II′ of FIG. 1 and a cross-sectional portion of an oxide layer 130 and a second capacitor pattern 140 along line III-III′ of FIG. 1.

Referring to FIG. 4, the method of manufacturing a hybrid capacitor according to one embodiment of the present invention includes forming a plurality of first trenches in a silicon substrate (S110), forming a first capacitor pattern on the silicon substrate along the plurality of first trenches (S120), forming an oxide layer on the first capacitor pattern (S130), forming a plurality of second trenches in the oxide layer (S140), forming a second capacitor pattern on the oxide layer along a plurality of second trenches (S150), and forming a through-hole passing through at least a portion of the second capacitor pattern and the oxide layer (S160). Here, the through-hole includes a conductive connection pattern that electrically connects the first capacitor pattern and the second capacitor pattern.

First, as shown in FIGS. 4 and 5, in a hybrid capacitor 100 of the present invention, a silicon substrate 110 is patterned to form a plurality of first trenches T1. The silicon substrate 110 may be patterned by arranging a plurality of mask patterns on the silicon substrate 110 and then performing a photoresist process and an etching process.

The plurality of first trenches T1 formed through such a photoresist process may have an angle of 90 degrees with respect to an upper surface of the silicon substrate 110. The plurality of first trenches T1 may be formed to each have a preset depth at a preset equal interval.

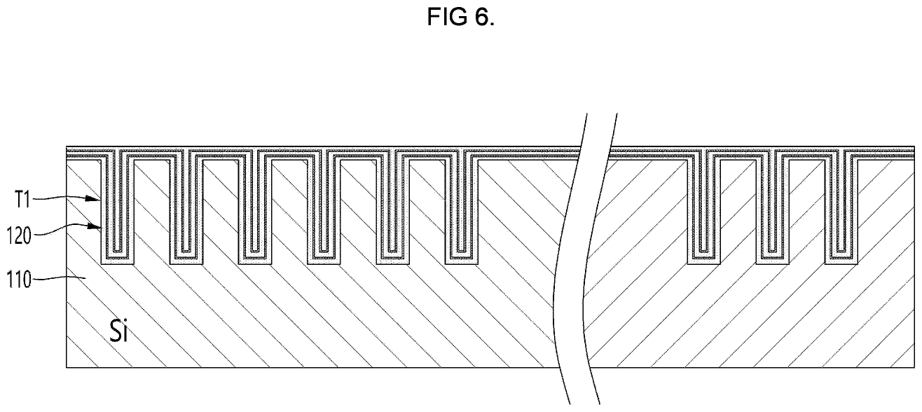

Thereafter, as shown in FIGS. 4 and 6, a first capacitor pattern 120 is formed by alternating a first capacitor dielectric layer 122 and at least one first capacitor electrode layer 121 on the silicon substrate 110, in which the plurality of first trenches T1 are formed, along the plurality of first trenches T1.

Next, a thinning process may be performed to remove a bottom surface of the silicon substrate 110. The thinning process is a process of removing the bottom surface of the silicon substrate 110 within a range that does not affect the plurality of first trenches T1 of the silicon substrate 110. The thinning process for the silicon substrate 110 may make the silicon substrate 110 thin through any suitable process such as a chemical mechanical polishing (CMP) process, an etch back process, or any combination thereof. Accordingly, the hybrid capacitor 100 may have high-performance capacitance while having an ultra-small size.

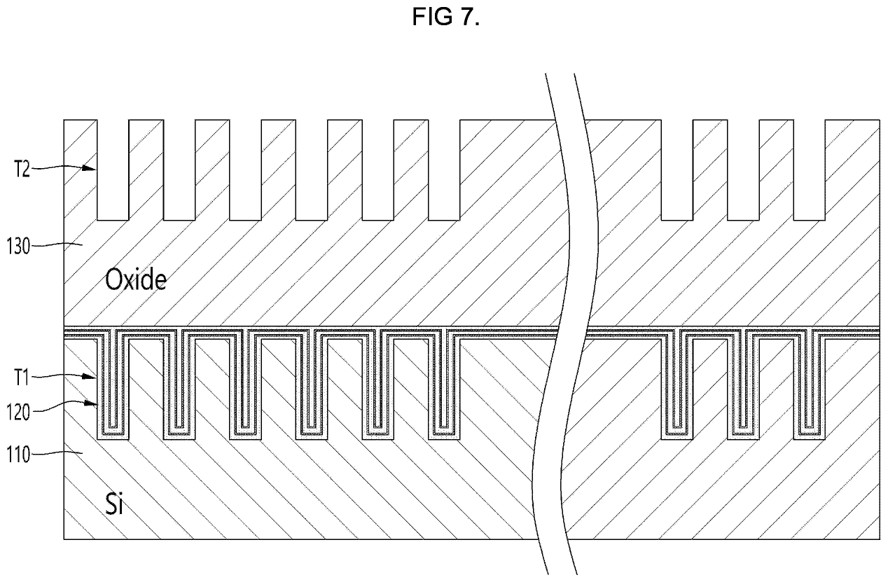

Thereafter, as shown in FIGS. 4 and 7, an oxide layer 130 is formed on the silicon substrate 110 on which the first capacitor pattern 120 is formed, and then a plurality of second trenches T2 are formed at an angle of 90 degrees with respect to an upper surface of the oxide layer 130. Each of the plurality of second trenches T2 may be disposed to correspond to the plurality of first trenches T1. That is, the plurality of second trenches T2 may be formed to each have a preset depth at a preset equal interval. The oxide layer 130 may be made of an insulating material including oxide and may be formed through chemical vapor deposition (CVD), physical vapor deposition (PVD), atomic layer deposition (ALD), a diffusion process, or any combination thereof.

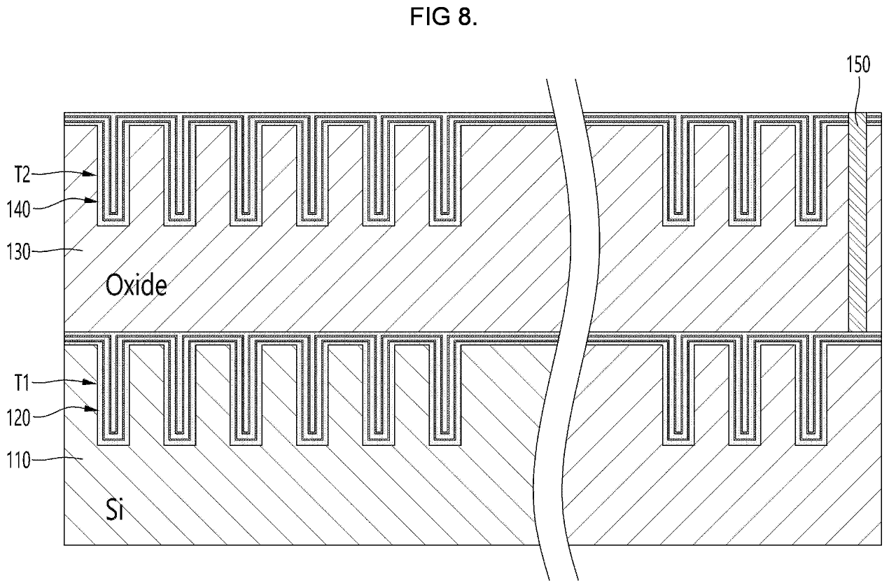

Thereafter, as shown in FIGS. 4 and 8, a second capacitor pattern 140 is formed by alternating a plurality of third capacitor electrode layers 141 and one or more second capacitor dielectric layers 142 on the oxide layer 130, in which the plurality of second trenches T2 are formed, along the plurality of second trenches T2. Afterwards, a hole is formed to pass through the oxide layer 130, and then the hole is filled with a metal material to form a through-hole 150 such that the first capacitor pattern 120 and the second capacitor pattern 140 are electrically connected.

In general, when a first capacitor and a second capacitor are vertically stacked on each silicon substrate in which deep trenches are formed, a process of joining the first capacitor and the second capacitor is performed. Not only is there a separate joining process, but there is also a problem of difficulty in aligning during the joining process. However, in the hybrid capacitor 100 according to one embodiment of the present invention, since the first capacitor pattern 120 in the form of a deep trench is formed on the silicon substrate 110, the oxide layer 130 is formed on the silicon substrate 110 on which the first capacitor pattern 120 is formed, and then the second capacitor pattern 140 in the form of a deep trench is formed on the oxide layer 130, a separate joining process can be omitted, and an aligning process can also be omitted.

A hybrid capacitor and a method of manufacturing the same according to various embodiments of the present invention may be described as follows.

The hybrid capacitor according to one embodiment of the present invention includes a silicon substrate, a first capacitor pattern disposed on the silicon substrate along a plurality of first trenches, an oxide layer formed on the silicon substrate on which the first capacitor pattern is disposed, a second capacitor pattern disposed on the oxide layer along a plurality of second trenches, and a through-hole electrically connecting the first capacitor pattern and the second capacitor pattern.

According to another embodiment of the present invention, the first capacitor pattern may be arranged in a first direction on an upper surface of the silicon substrate, and the second capacitor pattern may be arranged in a second direction intersecting the first direction on an upper surface of the oxide layer.

According to still another embodiment of the present invention, the first capacitor pattern may be arranged in the first direction on the upper surface of the silicon substrate, and the second capacitor pattern may be arranged perpendicular to the first direction on the upper surface of the oxide layer.

According to yet another embodiment of the present invention, the plurality of first trenches may be spaced a preset interval apart from each other on the silicon substrate and may be formed to have a preset depth from an upper surface of the silicon substrate.

According to yet another embodiment of the present invention, each of the plurality of second trenches may be formed to correspond to a preset number of first trenches in the oxide layer and may be formed at the same interval and the same depth as each of the plurality of first trenches.

According to yet another embodiment of the present invention, the first capacitor pattern may include a first capacitor electrode layer formed on the upper surface of the silicon substrate along the plurality of first trenches, a first capacitor dielectric layer formed to cover at least one surface of the first capacitor electrode layer, and a second capacitor electrode layer formed to cover at least one surface of the first capacitor dielectric layer.

According to yet another embodiment of the present invention, the second capacitor pattern may include a third capacitor electrode layer formed on the upper surface of the oxide layer along the plurality of second trenches, a second capacitor dielectric layer formed to cover at least one surface of the third capacitor electrode layer, and a fourth capacitor electrode layer formed to cover at least one surface of the second capacitor dielectric layer.

According to yet another embodiment of the present invention, the first capacitor pattern may further include at least one first additional capacitor dielectric layer formed to cover the second capacitor electrode layer, and at least one first additional electrode layer disposed to alternate with the at least one first additional capacitor dielectric layer, and the second capacitor pattern may further include at least one second additional capacitor dielectric layer formed to cover the fourth capacitor electrode layer, and at least one second additional electrode layer disposed to alternate with the at least one second additional capacitor dielectric layer.

A method of manufacturing a hybrid capacitor according to one embodiment of the present invention includes forming a plurality of first trenches in a silicon substrate, forming a first capacitor pattern on the silicon substrate along the plurality of first trenches, forming an oxide layer on the first capacitor pattern, forming a plurality of second trenches in the oxide layer, forming a second capacitor pattern on the oxide layer along the plurality of second trenches, and forming a through-hole passing through at least a portion of the second capacitor pattern and the oxide layer, wherein the through-hole includes a conductive connection pattern that electrically connects the first capacitor pattern and the second capacitor pattern.

According to another embodiment of the present invention, the forming of the first capacitor pattern may be forming the first capacitor pattern to extend in a first direction on an upper surface of the silicon substrate, and the forming of the second capacitor pattern may be forming the second capacitor pattern to extend perpendicular to an extending direction of the first capacitor pattern on an upper surface of the oxide layer.

According to still another embodiment of the present invention, the forming of the first capacitor pattern may include forming a first capacitor electrode layer along an upper surface of the silicon substrate in which the plurality of first trenches are formed, forming a first capacitor dielectric layer on the first capacitor electrode layer, and forming a second capacitor electrode layer on the first capacitor dielectric layer.

According to yet another embodiment of the present invention, the forming of the second capacitor pattern may include forming a third capacitor electrode layer along an upper surface of the oxide layer in which the plurality of second trenches are formed, forming a second capacitor dielectric layer on the third capacitor electrode layer, and forming a fourth capacitor electrode layer on the second capacitor dielectric layer.

According to yet another embodiment of the present invention, the forming of the first capacitor pattern may further include forming at least one first additional capacitor dielectric layer and at least one first additional capacitor dielectric layer on the second capacitor electrode layer to alternate with each other, and the forming of the second capacitor pattern may further include forming at least one second additional capacitor dielectric layer and at least one second additional capacitor dielectric layer on the fourth capacitor electrode layer to alternate with each other.

According to yet another embodiment of the present invention, the forming of the second capacitor pattern may be forming the second capacitor pattern having a corresponding shape at a position vertically corresponding to a shape of the first capacitor pattern.

According to yet another embodiment of the present invention, the forming of the first capacitor pattern may further include, after the forming of the first capacitor pattern, removing a portion of a bottom surface of the silicon substrate.

According to the present invention, two capacitor patterns disposed to be vertically separated by an oxide layer are connected in parallel through a through-hole, thereby addressing a shortcoming of a deep trench capacitor and also increasing capacitance.

According to the present invention, a second capacitor pattern is formed after an oxide layer is formed on a first capacitor pattern formed on a silicon substrate, thereby increasing capacitance, omitting a separate joining process and an aligning process for the oxide layer to form the second capacitor pattern, and simplifying a process of manufacturing a capacitor.

According to the present invention, it is possible to construct a capacitor with high capacitance within a thin and narrow area and solve a problem that a wafer is vulnerable during a process of grinding silicon to be thin for such a construction.

The effects obtainable in the present invention are not limited to the effects described above, and other effects that are not described will be clearly understood by a person skilled in the art from the description below.

In the present specification, respective blocks or respective operations may indicate modules, segments, or some of codes including at least one executable instruction for executing a specific logical function(s). In addition, in several alternative embodiments, it is noticed that the functions described in the blocks or the operations may run out of order. For example, two successive blocks and operations may be substantially executed simultaneously or often in reverse order according to corresponding functions.

Operations of methods or algorithms described in connection with the embodiments disclosed herein may be embodied directly in hardware, in a software module executed by a processor, or in a combination of the two. A software module may reside in a random access memory (RAM), a flash memory, a read only memory (ROM), an electrically programmable ROM (EPROM), an electrically erasable programmable ROM (EEPROM), a register, a hard disk, a removable disk, a CD-ROM, or any other form of storage medium known in the art. An exemplary recording medium or storage medium is coupled to a processor, and the processor can read information from, and write information to, the recording medium or storage medium. Alternatively, the recording medium or storage medium may be integral with the processor. The processor and recording or storage medium may reside in an application specific integrated circuit (ASIC). The ASIC may reside in a user terminal. Alternatively, the processor and the storage medium may reside as separate components in the user terminal.

Although embodiments of the present invention have been described in more detail with reference to the accompanying drawings, the present invention is not necessarily limited to these embodiments, and various modifications may be made without departing from the technical spirit of the present invention. Accordingly, the embodiments disclosed in the present invention are not intended to limit the technical idea of the present invention, but are for illustrative purposes, and the scope of the technical idea of the present invention is not limited by these embodiments. Accordingly, it should be understood that the above-described embodiments are exemplary in all respects and not restrictive. The spirit and scope of the present invention should be interpreted by the appended claims and encompass all equivalents falling within the scope of the appended claims.

What is claimed is:

1. A hybrid capacitor comprising:
a silicon substrate;
a first capacitor pattern disposed on the silicon substrate along a plurality of first trenches;
an oxide layer formed on the silicon substrate on which the first capacitor pattern is disposed;
a second capacitor pattern disposed on the oxide layer along a plurality of second trenches; and
a through-hole configured to electrically connect the first capacitor pattern and the second capacitor pattern.

2. The hybrid capacitor of claim 1, wherein the first capacitor pattern is arranged in a first direction on an upper surface of the silicon substrate, and
the second capacitor pattern is arranged in a second direction intersecting the first direction on an upper surface of the oxide layer.

3. The hybrid capacitor of claim 2, wherein the first capacitor pattern is arranged in the first direction on the upper surface of the silicon substrate, and
the second capacitor pattern is arranged perpendicular to the first direction on the upper surface of the oxide layer.

4. The hybrid capacitor of claim 2, wherein the plurality of first trenches are spaced apart from each other at a preset interval on the silicon substrate and are each formed to have a preset depth from an upper surface of the silicon substrate.

5. The hybrid capacitor of claim 4, wherein each of the plurality of second trenches is formed to correspond to a preset number of the plurality of first trenches in the oxide layer and is formed at the same interval and the same depth as each of the plurality of first trenches.

6. The hybrid capacitor of claim 2, wherein the first capacitor pattern includes a first capacitor electrode layer formed on the upper surface of the silicon substrate along the plurality of first trenches, a first capacitor dielectric layer formed to cover at least one surface of the first capacitor electrode layer, and a second capacitor electrode layer formed to cover at least one surface of the first capacitor dielectric layer.

7. The hybrid capacitor of claim 6, wherein the second capacitor pattern includes a third capacitor electrode layer formed on the upper surface of the oxide layer along the plurality of second trenches, a second capacitor dielectric layer formed to cover at least one surface of the third capacitor electrode layer, and a fourth capacitor electrode layer formed to cover at least one surface of the second capacitor dielectric layer.

8. The hybrid capacitor of claim 7, wherein the first capacitor pattern further includes at least one first additional capacitor dielectric layer formed to cover the second capacitor electrode layer, and at least one first additional electrode layer arranged to alternate with the at least one first additional capacitor dielectric layer, and
the second capacitor pattern further includes at least one second additional capacitor dielectric layer formed to cover the fourth capacitor electrode layer, and at least one second additional electrode layer arranged to alternate with the at least one second additional capacitor dielectric layer.

9. A method of manufacturing a hybrid capacitor, the method comprising:
forming a plurality of first trenches in a silicon substrate;
forming a first capacitor pattern on the silicon substrate along the plurality of first trenches;
forming an oxide layer on the first capacitor pattern;
forming a plurality of second trenches in the oxide layer;
forming a second capacitor pattern on the oxide layer along the plurality of second trenches; and
forming a through-hole passing through at least a portion of the second capacitor pattern and the oxide layer,
wherein the through-hole includes a conductive connection pattern configured to electrically connect the first capacitor pattern and the second capacitor pattern.

10. The method of claim 9, wherein the forming of the first capacitor pattern includes forming the first capacitor pattern to extend in a first direction on an upper surface of the silicon substrate, and
the forming of the second capacitor pattern includes forming the second capacitor pattern to extend perpendicular to an extending direction of the first capacitor pattern on an upper surface of the oxide layer.

11. The method of claim 10, wherein the forming of the first capacitor pattern includes forming a first capacitor electrode layer along an upper surface of the silicon substrate in which the plurality of first trenches are formed, forming a first capacitor dielectric layer on the first capacitor electrode layer, and forming a second capacitor electrode layer on the first capacitor dielectric layer.

12. The method of claim 11, wherein the forming of the second capacitor pattern includes forming a third capacitor electrode layer along an upper surface of the oxide layer in which the plurality of second trenches are formed, forming a second capacitor dielectric layer on the third capacitor electrode layer, and forming a fourth capacitor electrode layer on the second capacitor dielectric layer.

13. The method of claim 12, wherein the forming of the first capacitor pattern further includes forming at least one first additional capacitor dielectric layer and at least one first additional capacitor dielectric layer on the second capacitor electrode layer to alternate with each other, and
the forming of the second capacitor pattern further includes forming at least one second additional capacitor dielectric layer and at least one second additional capacitor dielectric layer on the fourth capacitor electrode layer to alternate with each other.

14. The method of claim 10, wherein the forming of the second capacitor pattern includes forming the second capacitor pattern having a corresponding shape at a position vertically corresponding to a shape of the first capacitor pattern.

15. The method of claim 9, further comprising, after the forming of the first capacitor pattern, removing a portion of a bottom surface of the silicon substrate.
